(19) United States
(12) Patent Application Publication
(10) Pub. No.: US 2007/0239664 A1
(43) Pub. Date: Oct. 11, 2007

(54) System and method of implementing system-maintained index maintanence

(76) Inventors: Eric L. Barsness, Pine Island, MN (US); John M. Santosuosso, Rochester, MN (US)

Correspondence Address: IBM CORPORATION, 3605 HIGHWAY 52 NORTH, DEPT 917, ROCHESTER, MN, 55901-7829, US

(21) Appl. No.: 11/398,957

(22) Filed: Apr. 6, 2006

(51) Int. Cl. G06F 17/30

(52) U.S. Cl. 707/2

(57) ABSTRACT

A system, method, and computer-usable medium for interfacing an application with a database; implementing a collection of indexes, wherein the collection of indexes facilitate faster access by the application to data stored in the database; detecting a query by the application to the database for particular data; and in response to detecting the query, utilizing a collection of factors to determine whether a new index should be created within the collection of indexes to facilitate access to the particular data.

### BACKGROUND OF THE INVENTION

1. Technical Field

The present invention relates in general to the field of data processing systems and more specifically, relates to the field of computer database management systems. Still more specifically, the present invention relates to managing automated creation and maintenance of indexes over database files.

2. Description of the Related Art

The latest iteration of the OS/400 platform, i5/OS Version 5, Release 4 (V5R4) enables the operating system to automatically create an index when queries are being executed repeatedly against a file that would benefit from an index that has not been previously created. However, simply creating frequently-requested indexes may affect system performance. Therefore, there is a need for a system and method addressing the abovementioned limitation.

### SUMMARY OF THE INVENTION

The present invention includes a system, method, and computer-usable medium for interfacing an application with a database; implementing a collection of indexes, wherein the collection of indexes facilitate faster access by the application to data stored in the database; detecting a query by the application to the database for particular data; and in response to detecting the query, utilizing a collection of factors to determine whether a new index should be created within the collection of indexes to facilitate access to the particular data.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 is block diagram illustrating an exemplary data processing system in which a preferred embodiment of the present invention may be implemented;

FIG. 2 is a block diagram depicting exemplary contents of a system memory in which a preferred embodiment of the present invention may be implemented;

FIG. 3 is a high-level logical flowchart illustrating an exemplary method of implementing system-maintained index maintenance according to a preferred embodiment of the present invention.

### DETAILED DESCRIPTION OF A PREFERRED EMBODIMENT

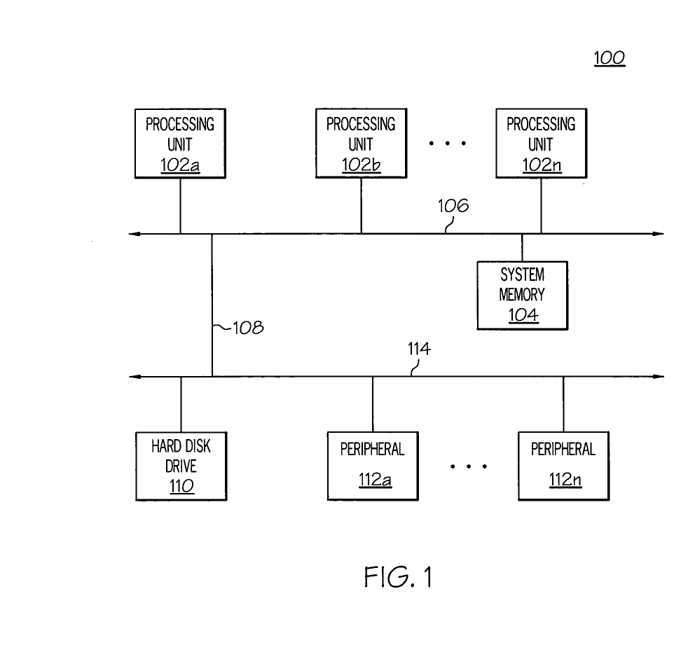

FIG. 1 is a block diagram illustrating an exemplary data processing system 100 in which a preferred embodiment of the present invention may be implemented. As depicted, exemplary data processing system 100 includes processing unit(s) 102, shown as processing units 102a-n in FIG. 1, which are coupled to system memory 104 via system bus 106. Preferably, system memory 104 may be implemented as a collection of dynamic random access memory (DRAM) modules. Typically, system memory 104 includes data and instructions for running a collection of applications. Mezzanine bus 108 acts as an intermediary between system bus 106 and peripheral bus 114. Those with skill in this art will appreciate that peripheral bus 114 may be implemented as a peripheral component interconnect (PCI), accelerated graphics port (AGP), or any other peripheral bus. Coupled to peripheral bus 114 is hard disk drive 110, which is utilized by data processing system 100 as a mass storage device. Also coupled to peripheral bus 114 is a collection of peripherals 112a-n.

Those skilled in the art will appreciate that data processing system 100 can include many additional components not specifically illustrated in FIG. 1. Because such additional components are not necessary for an understanding of the present invention, they are not illustrated in FIG. 1 or discussed further herein. It should also be understood, however, that the enhancements to data processing system 100 for implementing personalized alerts utilizing a user registry in instant messenger provided by the present invention are applicable to data processing systems of any system architecture and are in no way limited to the generalized multi-processor architecture or symmetric multi-processing (SMP) architecture illustrated in FIG. 1.

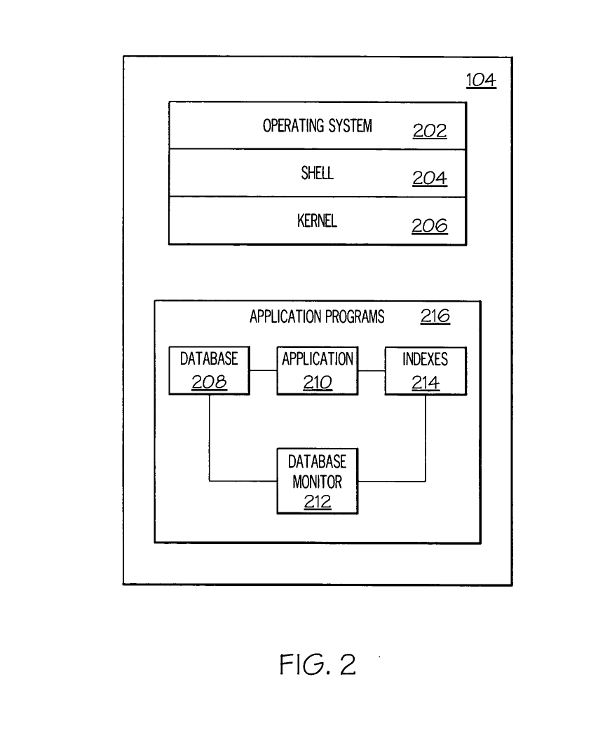

FIG. 2 is a block diagram depicting exemplary contents of system memory 104 of FIG. 1 according to a preferred embodiment of the present invention. As illustrated, system memory 104 includes operating system 202, which further includes shell 204 for providing transparent user access to resources such as application programs 216. Generally, shell 204 is a program that provides an interpreter and an interface between the user and the operating system. More specifically, shell 204 executes commands that are entered into a command line user interface or a file. Thus, shell 204 (as it is called in UNIX®), also called a command processor in Windows®, is generally the highest level of the operating system software hierarchy and servers as a command interpreter. The shell provides a system prompt, interprets commands entered by keyboard, mouse, or other user input media, and sends the interpreted command(s) to the appropriate lower levels of the operating system (e.g., kernel 206) for processing. Note that while shell 204 is a text-based, line-oriented user interface, the present invention will support other user interface modes, such as graphical, voice, gestural, etc. equally well.

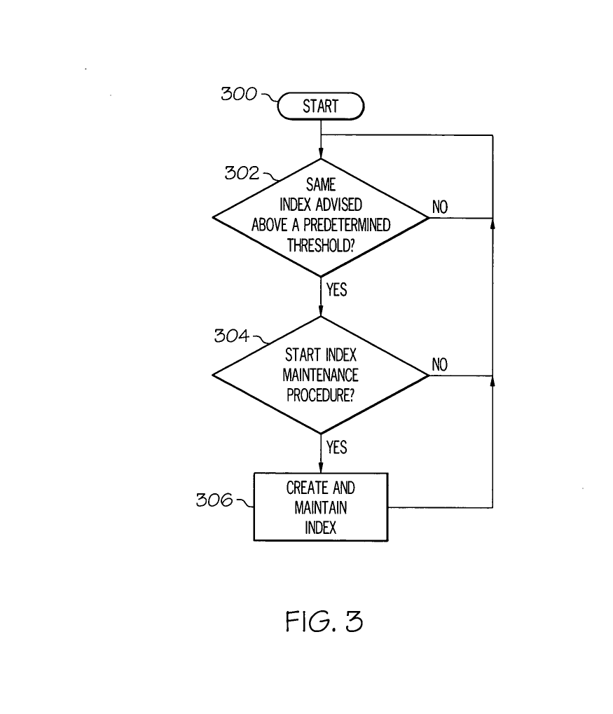

As illustrated, operating system 202 also includes kernel 206, which includes lower levels of functionality for operating system 202, including providing essential services required by other parts of operating system 202 and application programs 216, including memory management, process and task management, disk management, and mouse and keyboard management. Application programs 216 include database 208, application 210, database monitor 212, indexes 214 (all discussed herein in more detail in conjunction with FIG. 3), word processors, spreadsheets, and other application programs.

Database 208 may be implemented by any type of database that stores any type of data such as employee records, etc. Application 210 includes any type of software application that interfaces with database 208 to retrieve, manipulate, and process stored therein. Database monitor 212 oversees access to database 208 and depending on a collection of factors, determines whether an index to frequently accessed data stored within database 208 should be created and maintained within indexes 214 to facilitate faster access to the data. Database monitor 212 and indexes 214 can be implemented as a database management system (DBMS).

FIG. 3 is a high-level logical flowchart diagram illustrating an exemplary method of implementing system-maintained index maintenance according to a preferred embodiment of the present invention. The process begins at step 300 and proceeds to step 302, which illustrates database monitor 212 determining if particular queries that could benefit from an additional index have been executed by application 210 frequently enough (as compared to a predetermined threshold) to consider creating an index within indexes 214 to the particular data. If database monitor 212 determines that queries to database 208 that could benefit from an additional index have been executed by application 210 have not been requested enough (as compared to the predetermined threshold), the process iterates at step 302. If, however, database monitor 212 determines that particular queries have been requested frequently enough as compared to a predetermined threshold, the process continues to step 304, which illustrates database monitor determining whether to start an index maintenance procedure to create and maintain an index within indexes 214. Database monitor 212 utilizes a collection of criteria including, but not limited to determining:

(1) if the associated application (e.g., application 210) has a flag that disables system-maintained indexes.

(2) if any time restrictions exist. For example, there may be peak operating times when data processing system resources are scarce and the creation of and maintenance of indexes may not be desirable for efficient operation.

(3) the amount of data processing system resources available for creating and maintaining indexes. For example, if data processing system 100 is in a condition with low memory and/or processing resources available, the added memory or storage utilized for the creation and maintenance of indexes may not be available.

(4) if there are any size restrictions on the memory utilized for storing indexes 214.

(5) before and after calculations of query execution times. For example, database monitor 212 could determine the amount of time required for a query execution with and without utilizing an index. If the time required for the query execution is significantly less with an index, the creation and maintenance of the index may be desirable.

(6) if the query is a time consuming query, which may be determined by a database administrator.

(7) if the creation and maintenance of indexes are limited to specific users of data processing system 100.

(8) if the creation and maintenance of a specific index will improve the query execution time by at least a predetermined threshold.

If, utilizing the aforementioned criteria, database monitor 212 determines that the index maintenance procedure should be started, the process continues to step 306, which illustrates database monitor 212 creating and maintaining an index within indexes 214 to the specific data stored in database 208.

If, utilizing the aforementioned criteria, database monitor 212 determines that the index maintenance procedure should not be started, the process returns to step 302 and proceeds in an iterative fashion.

As discussed, the present invention includes a system, method, and computer-usable medium for interfacing an application with a database; implementing a collection of indexes, wherein the collection of indexes facilitate faster access by the application to data stored in the database; detecting a query by the application to the database for particular data; and in response to detecting the query, utilizing a collection of factors to determine whether a new index should be created within the collection of indexes to facilitate access to the particular data.

It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD-ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention.

What is claimed is:

1. A method comprising:
interfacing an application with a database;
implementing a plurality of indexes, wherein said plurality of indexes facilitates faster access by said application to data stored in said database;
detecting a query by said application to said database for particular data; and
in response to said detecting said query, utilizing a plurality of factors to determine whether a new index should be created within said plurality of indexes to facilitate access to said particular data.

2. The method according to claim 1, wherein said plurality of factors further includes:
determining if said application includes a flag that disables creation of indexes.

3. The method according to claim 1, wherein said plurality of factors further includes:
comparing available data processing system resources to a predetermined threshold.

4. The method according to claim 1, wherein said plurality of factors further includes:
comparing a number of indexes of said plurality of indexes to a predetermined threshold number of indexes.

5. The method according to claim 1, wherein said plurality of factors further includes:
determining if creating an index within said plurality of index will improve execution times of further queries to said particular data by a predetermined period of time.

6. The method according to claim 1, wherein said plurality of factors further includes:
determining if creation and maintenance of indexes are limited to certain users of said application.

7. A system comprising:
a processor;
an interconnect coupled to said processor;
a computer-usable medium embodying computer program code, said computer-usable medium coupled to said interconnect, said computer program code comprising instructions executable by said processor and configured for:
interfacing an application with a database;
implementing a plurality of indexes, wherein said plurality of indexes facilitate faster access by said application to data stored in said database;
detecting a query by said application to said database for particular data; and
in response to said detecting said query, utilizing a plurality of factors to determine whether a new index should be created within said plurality of indexes to facilitate access to said particular data.

8. The system according to claim 7, wherein said wherein said plurality of factors further includes:
determining if said application includes a flag that disables creation of indexes.

9. The system according to claim 7, wherein said plurality of factors further includes:
comparing available data processing system resources to a predetermined threshold.

10. The system according to claim 7, wherein said plurality of factors further includes:
comparing a number of indexes of said plurality of indexes to a predetermined threshold number of indexes.

11. The system according to claim 7, wherein said plurality of factors further includes:
determining if creating an index within said plurality of index will improve execution times of further queries to said particular data by a predetermined period of time.

12. The system according to claim 7, wherein said plurality of factors further includes:
determining if creation and maintenance of indexes are limited to certain users of said application.

13. A computer-usable medium embodying computer program code, said computer program code comprising computer executable instructions configured for:
interfacing an application with a database;
implementing a plurality of indexes, wherein said plurality of indexes facilitates faster access by said application to data stored in said database;
detecting a query by said application to said database for particular data; and
in response to said detecting said query, utilizing a plurality of factors to determine whether a new index should be created within said plurality of indexes to facilitate access to said particular data.

14. The computer-usable medium according to claim 13, wherein said wherein said plurality of factors further includes:
determining if said application includes a flag that disables creation of indexes.

15. The computer-usable medium according to claim 13, wherein said plurality of factors further includes:
comparing available data processing system resources to a predetermined threshold.

16. The computer-usable medium according to claim 13, wherein said plurality of factors further includes:
comparing a number of indexes of said plurality of indexes to a predetermined threshold number of indexes.

17. The computer-usable medium according to claim 13, wherein said plurality of factors further includes:
determining if creating an index within said plurality of index will improve execution times of further queries to said particular data by a predetermined period of time.

18. The computer-usable medium according to claim 13, wherein said plurality of factors further includes:
determining if creation and maintenance of indexes are limited to certain users of said application.
